(19) United States
(12) Patent Application Publication
(10) Pub. No.: US 2009/0138198 A1
(43) Pub. Date: May 28, 2009

(54) APPARATUS AND METHOD FOR SHARING THE LANDMARK INFORMATION OF THE LOCATION SERVICE USING A JAVA RECORD MANAGEMENT SYSTEM IN A WIRELESS COMMUNICATION TERMINAL

(75) Inventors: Jae-Min Lee, Seoul (KR); Sung-Chan Lee, Yongin-si (KR); Hyun-Su Kim, Suwon-si (KR); Young-Soo Yun, Seoul (KR); Soo-Hyeon Lee, Suwon-si (KR); Ji-Hyun Kim, Incheon (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/273,676

(22) Filed: Nov. 19, 2008

(30) Foreign Application Priority Data
Nov. 23, 2007 (KR) 10-2007-0120049

(51) Int. Cl. G01C 21/00; H04W 4/00; G06F 9/455; G06F 7/00; G06F 7/06; G06F 17/30

(52) U.S. Cl. 701/213; 701/207; 455/466; 718/1; 707/101; 707/3; 707/E17.008; 707/E17.018; 707/E17.014

(57) ABSTRACT

A method and an apparatus for sharing landmark information of a location service in a wireless communication terminal are provided. The method includes obtaining location information in a JAVA application and storing the landmark information based the location information using a backup database format in a file system region.

### PRIORITY

This application claims priority the benefit under 35 U.S.C. §119(a) of a Korean patent application filed in the Korean Intellectual Property Office on Nov. 23, 2007 and assigned Serial No. 10-2007-0120049, the entire disclosure of which is hereby incorporated by reference.

### BACKGROUND OF THE INVENTION

1. Field of the Invention

The present invention relates to an apparatus and a method for a location service in a wireless communication system. More particularly, the present invention relates to an apparatus and a method for sharing landmark information of a location service using a JAVA Record Management System (RMS) in a wireless communication terminal.

2. Description of the Related Art

With advances in wireless technology, mobile communication terminals now offer a location service using a Global Positioning System (GPS). As a part of the location service, the terminal is able to display a map and a specific location on the map through a landmark function of the location service. For example, based on the input of a user, the landmark function is able to show the locations of movie theaters that are selected for the movies they are playing or the locations of restaurants, selected for the types of food they serve.

There are several conventional methods for providing the landmark function. One method is to download the landmark information from a landmark information database of a server that supports the location service and to which the user's terminal is registered. Another method is to utilize landmark information that is input by a user.

FIGS. 1A and 1B illustrate an example of a landmark function in a mobile communication terminal according to the conventional art.

Referring to FIG. 1A, a terminal displays a list of landmark information, in this example a list of movie theaters, after connecting to a server and downloading the landmark information from the server. FIG. 1B illustrates the displaying of the location of each movie theater corresponding to the landmark information on the map, when the landmark information is selected. In the landmark function illustrated in FIGS. 1A and 1B, if the landmark information is not registered in the corresponding landmark server, the terminal is unable to search and use the landmark information. That is, the terminal is dependent on the landmark server for any landmark information that it receives.

FIGS. 2A and 2B illustrate an example of another landmark function in a mobile communication terminal according to the conventional art.

Referring to FIG. 2A, information (latitude/longitude, time, a reference point) regarding the relevant landmark is input through a window by the user or is input by receiving position information from a GPS server. FIG. 2B illustrates the status of the stored landmark information of FIG. 2A. Here, it is difficult to share the landmark information with another user.

FIGS. 3A and 3B illustrate an example of another landmark function in a mobile communication terminal according to the conventional art.

Referring to FIGS. 3A and 3B, FIG. 3A illustrates an example of transmitting landmark information, which is stored in a first terminal, to a second terminal through a Multimedia Message System (MMS). FIG. 3B illustrates an example of the receipt of the landmark information in the second terminal. In the conventional art illustrated in FIGS. 3A and 3B, the first terminal may not be able to send all of the landmark information (name, description, coordinate, and address information) at one time, but may only be able to send a part of the information. That is, it may not be possible to transmit all of the landmark information at once.

As described above, in the conventional art, a terminal of FIGS. 1A and 1B must depend on the server for the location service to use landmark information, a terminal of FIGS. 2A and 2B has difficulty sharing the landmark information with another user and the terminal of FIGS. 3A and 3B cannot transmit all of the landmark information at once.

### SUMMARY OF THE INVENTION

An aspect of the present invention is to address at least the above mentioned problems and/or disadvantages and to provide at least the advantages described below. Accordingly, an aspect of the present invention is to provide an apparatus and a method for sharing landmark information of a location service using a JAVA Record Management System (RMS) in a wireless communication terminal.

In accordance with an aspect of the present invention, a method for sharing the landmark information of the location service in a wireless communication terminal is provided. The method includes obtaining location information in a JAVA application and storing the landmark information based on the location information using a backup database format in a file system region.

In accordance with another aspect of the present invention, a method for sharing landmark information of a location service in a wireless communication terminal is provided. The method includes requesting landmark information in a file system region, obtaining the landmark information file from a backup database, porting the RMS region to a Record Management System (RMS) region and updating the landmark information file in the RMS region.

In accordance with yet another aspect of the present invention, an apparatus for sharing landmark information of a location service in a wireless communication terminal is provided. The apparatus includes a controller for obtaining location information in a JAVA application and a file system unit for storing the landmark information based on the location information using a backup database format in a file system region.

In accordance with still another aspect of the present invention, an apparatus for sharing landmark information of a location service in a wireless communication terminal is provided. The apparatus includes a file system unit for requesting the landmark information in a file system region and for obtaining the landmark information file from a backup database, a file system porting unit for porting to a Record Management System (RMS) region and a record management unit for updating the landmark information file in the RMS region.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments the present invention will be more apparent from the following description taken in conjunction with the accompanying drawings, in which:

FIGS. 1A and 1B illustrate an example of a landmark function in a mobile communication terminal according to the conventional art;

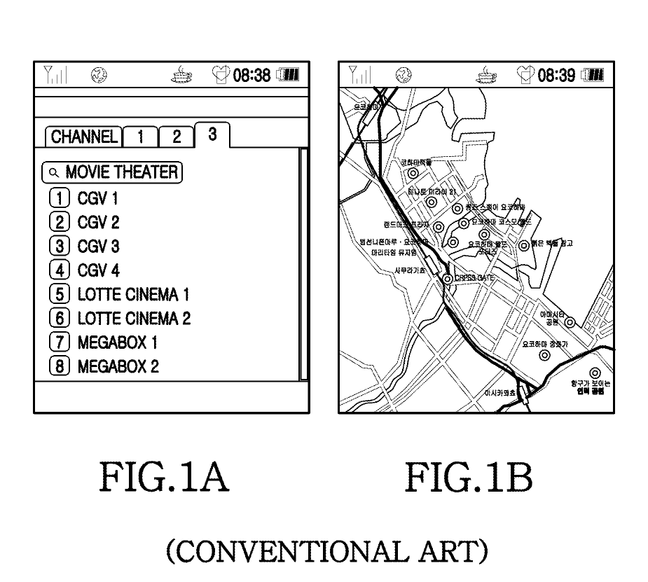

FIGS. 2A and 2B illustrate an example of another landmark function in a mobile communication terminal according to the conventional art;

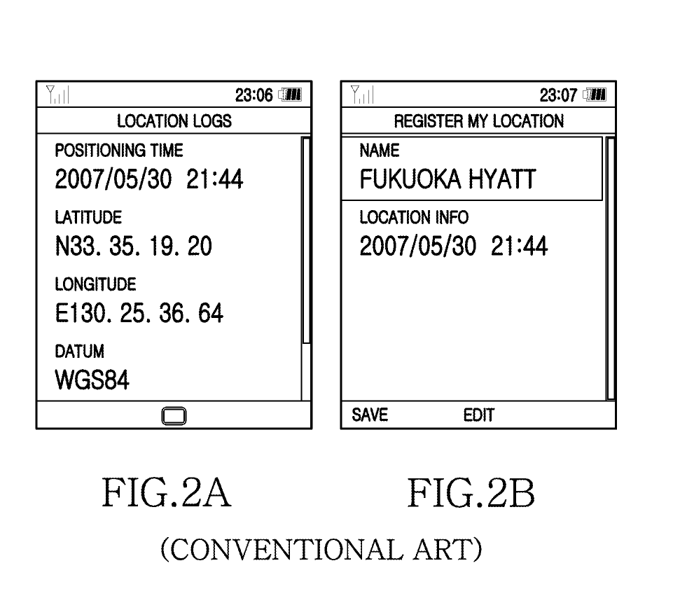

FIGS. 3A and 3B illustrate an example of another landmark function in a mobile communication terminal according to the conventional art;

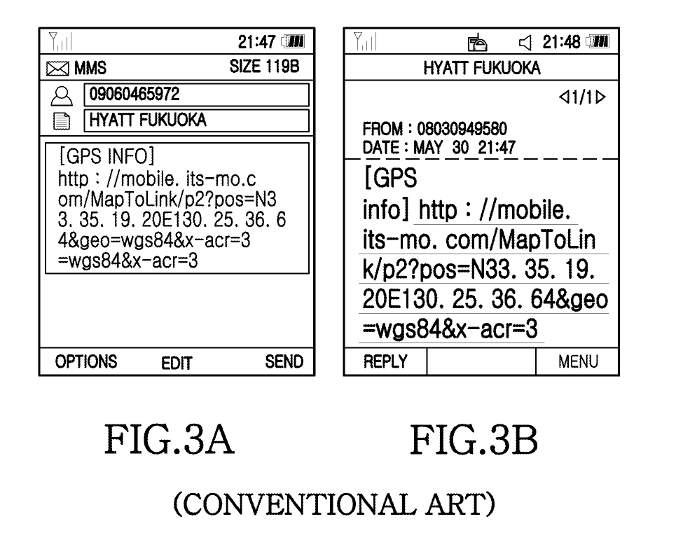

FIG. 4 illustrates an apparatus for sharing landmark information of a location service in a wireless communication terminal according to an exemplary embodiment of the present invention;

FIG. 5 illustrates an operation of a first terminal for sharing landmark information of a location service in a wireless communication terminal according to an exemplary embodiment of the present invention;

FIG. 6 illustrates an operation of a second terminal for sharing landmark information of a location service in a wireless communication terminal according to an exemplary embodiment of the present invention.

FIG. 7 illustrates the storage of landmark information according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide an apparatus and a method for sharing landmark information of a location service using a JAVA Record Management System (RMS) in a wireless communication terminal.

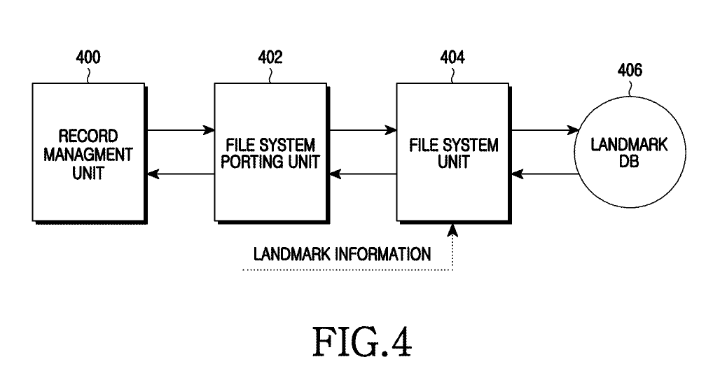

FIG. 4 illustrates an apparatus for sharing landmark information of a location service in a wireless communication terminal according to an exemplary embodiment of the present invention.

Referring to FIG. 4, a record management unit 400 and a file system porting unit 402 receive information of a specific location in a JAVA application.

For example, the record management unit 400 requests landmark information based on location information determined from a Global Positioning System (GPS) in a Record Management System (RMS) region, after porting the landmark information to the RMS region, and stores the landmark information in a predefined record format in a database of the RMS region. The file system porting unit 402 performs porting to a file system unit 404, to access a file (e.g. a landmark information file) upon receiving the request for the landmark information. Although not illustrated, the apparatus may further include a controller for obtaining the location information. In an exemplary implementation, the controller includes the record management unit 400 and the file system porting unit 402.

The file system unit 404 stores the landmark information record based on the location information in a backup database format in a file system region. Also, the file system unit 404 requests the landmark information which is stored in the file system region, and obtains the landmark information file from a backup landmark database 406.

Here, the landmark information stored in the backup database format is provided to the corresponding terminal, using a web posting or a web download based internet communication, a Multimedia Messaging Service (MMS), a Bluetooth communication or an IrDA communication.

In an exemplary implementation, the JAVA application, which supports the location service, complies with the JSR-179 specification and processes in a file system region when generating/adding/deleting the landmark information

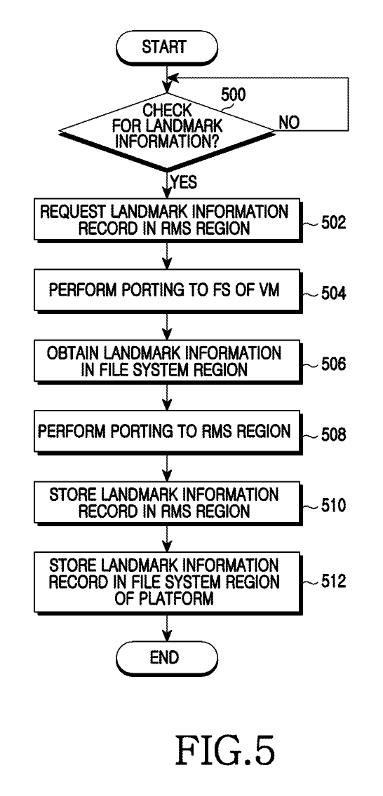

FIG. 5 illustrates an operation of a first terminal for sharing landmark information of a location service in a wireless communication terminal according to an exemplary embodiment of the present invention.

Referring to FIG. 5, the terminal determines if an input requesting landmark information is received in step 500. If it is determined that a request for landmark information is received in step 500, the terminal requests a landmark information record in the RMS region of a JAVA application in step 502.

In step 504, the terminal performs porting to a file system region of a Virtual Machine (VM) to obtain the landmark information of the file system region. That is, the terminal converts data formatted for the RMS region into data formatted for the file system region or data formatted for the file system region into data formatted for the RMS region.

In step 506, the terminal obtains the landmark information from the file system region. The landmark information of the file system region may be directly input by the user or provided from a GPS.

In step 508, the terminal ports the landmark information of the file system region to the RMS region. In step 510, the terminal stores the landmark information as a record in the RMS region.

In step 512, the terminal stores the landmark information record, which is updated or changed, in the file system region of the platform. Step 512 may progress at any point between step 502 and step 510.

Next, the terminal finishes this process.

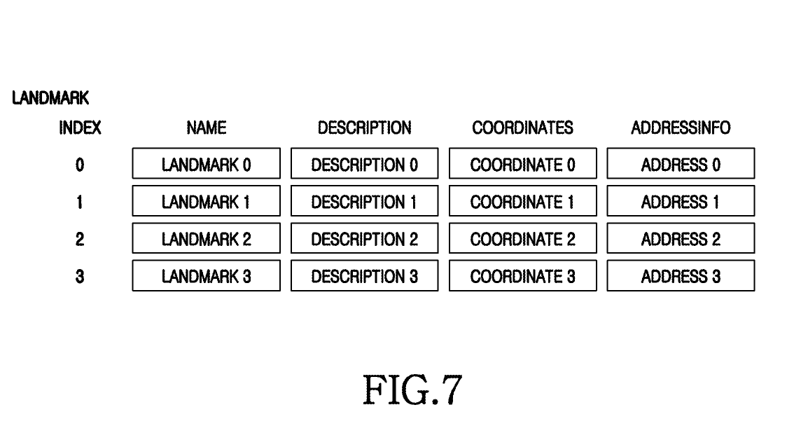

As described above with reference to FIG. 5, when the JAVA application stores the landmark information based on the location information from GPS, the JAVA application generates at least one landmark record using an RMS Application Program Interface (API), called a landmark store. In an exemplary implementation, the landmark information, which the JAVA application uses, is stored having a record format that includes “name”, “description”, “coordinate”, and “address information” values based on the JSR-179 specification (see FIG. 7). The RMS API layer stores the landmark record in the RMS region, through the file system porting layer running a JAVA Virtual Machine (VM) and a file system API of the platform porting VM.

For storing the landmark record in the RMS region, if the request of a new landmark generation/addition for the landmark record is forwarded to the platform, it opens a corresponding file in the file system of the platform (not in the RMS region of the JAVA application), and updates the landmark record. That is, the file of the backup database includes the necessary information, which the JAVA application uses. For example, the file is used when sharing the landmark information between the terminals supporting JSR-179, and has been configured to access and obtain the necessary information for a landmark at any time.

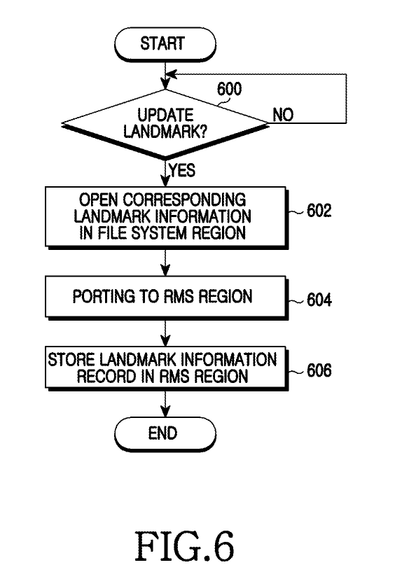

FIG. 6 illustrates an operation of a second terminal for sharing landmark information of a location service in a wireless communication terminal according to an exemplary embodiment of the present invention.

Referring to FIG. 6, the second terminal determines if updated landmark information is requested in step 600. If the second terminal determines in step 600 that updated landmark information is requested, it opens the file including the necessary information for a corresponding landmark in the file system region in step 602. The file includes a set of landmark information records.

Then, the second terminal receives the landmark information file from the first terminal (FIG. 5), which is located a distance away. In an exemplary implementation, the second terminal receives the landmark information through an MMS service. In another exemplary implementation, the second terminal may receive the landmark information file through Bluetooth communication or IrDA communication, from the first terminal, if it is located a short distance away.

In step 604, the second terminal performs porting to the RMS region. In step 606, the second terminal stores the landmark information record in the RMS region of the JAVA application.

Next, the terminal finishes this process.

In FIG. 5, the first terminal is the terminal that generates the landmark information in the record format, and in FIG.6, the second terminal is the terminal that obtains and uses the landmark file in the file system region.

FIG. 7 illustrates the storage of landmark information according to an exemplary embodiment of the present invention.

Referring to FIG. 7, the landmark information, which the JAVA application uses, may be stored as a record format that includes “name”, “description”, “coordinate”, and “address information” values based on the JSR-179 specification.

In accordance with the above described invention, if a user of a first terminal, having the JAVA application supporting the landmark service, has a special interest in, for example, collecting Long Play (LP) records and listening to music, in the conventional art, it is not easy to obtain information relating to the user's hobby. Rather, the typical information available from a server includes only popular categories and landmark information, for example, information about universal hotels, universal theaters, and the like. However, according to an exemplary embodiment of the present invention, if a user of terminal B having the same hobby creates an Internet blog that includes landmark information file for the location of an LP record store, the user of terminal A may download the landmark information file and apply to it the location service through the JAVA application. Moreover, the user of terminal A may also share it with the users of terminals C and D with the same hobby. Furthermore, the sharing may be accomplished through an MMS service, a Bluetooth communication and the like.

As described above, exemplary embodiments of the present invention provide benefits regarding the management of landmark information and the ability to share the information more widely and easily than the landmark information methods of the conventional art

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for sharing landmark information of a location service in a wireless communication terminal, the method comprising:
obtaining location information in a JAVA application; and
storing landmark information based the location information using a backup database format in a file system region.

2. The method of claim 1, further comprising:
providing the stored landmark information to a corresponding terminal, using at least one of a web posting, a web download based internet communication, a multimedia message service (MMS), a Bluetooth communication, and an IrDA communication.

3. The method of claim 1, wherein the landmark information is formatted in accordance with the JSR-179 specification.

4. The method of claim 1, wherein the obtaining of the location information in the JAVA application comprises:
requesting the corresponding landmark information from a Record Management System (RMS) region;
obtaining the corresponding landmark information in the file system region;
porting the corresponding landmark information to the RMS region; and
storing the corresponding landmark information using a record format in a database of the RMS region, after porting to the RMS region.

5. The method of claim 4, further comprising running the JAVA application with a Virtual Machine (VM).

6. The method of claim 4, wherein the obtaining of the corresponding landmark information comprises at least one of inputting the corresponding landmark information by a user and obtaining the corresponding landmark information from a Global Positioning System (GPS).

7. A method for sharing landmark information of a location service in a wireless communication terminal, the method comprising:
requesting landmark information in a file system region;
obtaining the landmark information file;
porting the landmark information to a Record Management System (RMS) region; and
updating the landmark information file in the RMS region.

8. The method of claim 7, wherein the obtaining of the landmark information file comprises receiving the landmark information from at least one of a file download using the Internet, a Bluetooth communication and an IrDA communication.

9. An apparatus for sharing the landmark information of the location service in a wireless communication terminal, the apparatus comprising:
a controller for obtaining location information in a JAVA application; and
a file system unit for storing landmark information based the location information using a backup database format in a file system region.

10. The apparatus of claim 9, wherein the controller obtains the landmark information using at least one of a web posting, a web download based internet communication, a Multimedia Message Service (MMS), a Bluetooth communication, and an IrDA communication.

11. The apparatus of claim 9, wherein the landmark information record is formatted in accordance with the JSR-179 specification.

12. The apparatus of claim 9, wherein the controller comprises:
a record management unit for requesting the corresponding landmark information in the Record Management System (RMS) region, for obtaining the corresponding landmark information in the file system region; and
a file system porting unit for porting to the RMS region and for storing the landmark information using the record format in the database of the RMS region, after porting to the RMS region.

13. The apparatus of claim 9, wherein the file system unit obtains the landmark information in the file system region.

14. The apparatus of claim 9, wherein the JAVA application runs with a Virtual Machine (VM).

15. The apparatus of claim 12, wherein the landmark information is received from at least one of an input by a user and a Global Positioning System (GPS).

16. An apparatus for sharing landmark information of a location service in a wireless communication terminal, the apparatus comprising:
a file system unit for requesting the landmark information in a file system region, and for obtaining the landmark information file from a backup database;
a file system porting unit for porting to a Record Management System (RMS) region; and
a record management unit for updating the landmark information file in the RMS region.

17. The apparatus of claim 16, further comprising:
a storage unit for storing the landmark information record received through at least one of a file download using the Internet, a Bluetooth communication, and an IrDA communication.
